(19) United States
(12) Patent Application Publication
(10) Pub. No.: US 2009/0130984 A1
(43) Pub. Date: May 21, 2009

(54) Apparatus and method for intercepting packet data in mobile communication system

(75) Inventor: Hyun-Ho Lee, Seongnami-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/975,545

(22) Filed: Oct. 19, 2007

(30) Foreign Application Priority Data
Oct. 20, 2006 (KR) 2006-0102358

(51) Int. Cl. H04B 17/00

(52) U.S. Cl. 455/67.11

(57) ABSTRACT

An apparatus and method for intercepting packet data in a mobile communication system is provided. The method includes the steps of: storing intercepted target and interception related information when a target provision request message including the intercepted target and interception related information is received from a Service Provider ADministration Function (SPADF); establishing a data session of the intercepted target according to whether the data session of the intercepted target is established; and intercepting a packet of the intercepted target when the intercepted target starts packet data communication. Accordingly, solutions capable of properly performing Lawful Interception (LI) can be provided while achieving compliance with existing LI on packet data.

### CROSS-REFERENCE TO RELATED APPLICATION(S) AND CLAIM OF

The present application claims the benefit under 35 U.S.C. § 119 (a) of Korean patent application filed in the Korean Intellectual Property Office on Oct. 20, 2006 and assigned Serial No. 2006-102358, the entire disclosure of which is hereby incorporated by reference.

### TECHNICAL FIELD OF THE INVENTION

The present application relates generally to a mobile communication system. More particularly, the present invention relates to an apparatus and method for intercepting packet data.

### BACKGROUND OF THE INVENTION

Lawful Interception (LI) is the interception of content of communication by law enforcement agencies in order to collect and analyze information for several reasons (e.g., public interest, criminal arrest, etc.). Almost all countries allow LI under laws, and thus, mobile communication providers have to provide LI functions when requested by a national surveillance agency. In particular, in North America, LI is specified in the Communication Assistance for Law Enforcement Act (CALEA). Recently, there has been a tendency to mandate LI not only for an existing voice communication service but also for a data communication service such as Voice over Internet Protocol (VoIP). Thus, in most cases, global telecommunication service providers request LI functions and solutions as a basic option when purchasing wired/wireless communication equipment.

To cope with such trend, existing mobile communication standard groups have enacted an LI standard so that mobile communication equipment can accept a LI function in compliance with the standard. Standardization of the LI standard is being conducted by two separate groups. First, in North America, J-STC-025 is a representative interception standard developed by a group of standard organizations for Code Division Multiple Access (CDMA) 2000 telecommunication equipment based on CDMA and in compliance with the 3rd Generation Partnership Project 2 (3GPP2) standard. Second, regarding telecommunication equipment based on Global System for Mobile (GSM) and in compliance with a 3GPP standard, a European Telecommunications Standard Institute (ETSI) technical specification is being standardized by an LI working group in the ETSI. These groups are performing standardization tasks so as to achieve cost-effective interception conforming to domestic and international treaties and laws.

At present, there is no LI standard currently available in a mobile WiMAX service. LI functions that satisfy the CALEA for the WiMAX service are requested by a Service Provider Working Group (SPWG) of a WiMAX forum related to standardization and authentication. However, since the conventional LI standard (i.e., J-STD-025B) defines an LI standard of audio/packet data for a CDMA 2000 system, it is difficult to apply the STC-025B to the mobile WiMAX service without alteration. In addition, inevitably, some parts of protocol content have to be modified. Moreover, it is difficult to provide an LI service according to the J-STD-025B. This is because the J-STD-025B defines only an LI architecture (see FIG. 1) and an e-interface between a Delivery Function (DF) and a Collection Function (CF). In other words, interfaces in association with exchange of LI information are not defined, for example, an a-interface and c-interface used for LI provision/change/de-provision/administration and a d-interface between the AF and the DF are not defined.

Accordingly, a LI standard that can be applied to a mobile WiMAX service is necessary. The LI standard has to be compliant with a conventional standard (i.e., J-STD-025B) and has to provide an LI service for serving packet data. Therefore, there is a need to define an LI architectures along with interfaces so that such LI service can be provided.

### SUMMARY OF THE INVENTION

To address the above-discussed deficiencies of the prior art, it is a primary aspect of the present invention to address at least the above-mentioned problems and/or disadvantages and to provide at least the advantages described below. Accordingly, an aspect of the present invention is to provide an apparatus and method for interception packet data in a mobile communication system.

Another aspect of the present invention is to provide definitions of function blocks having a Lawful Interception (LI) architecture and definitions of interfaces between the function blocks in a mobile communication system.

According to an aspect of the present invention, a method of intercepting packet data by an Access Function (AF) of a service provider in a mobile communication system is provided. The method includes the steps of: storing intercepted target and interception related information when a target provision request message including the intercepted target and interception related information is received from a Service Provider ADministration Function (SPADF); establishing a data session of the intercepted target according to whether the data session of the intercepted target is established; and intercepting a packet of the intercepted target when the intercepted target starts packet data communication.

According to another aspect of the present invention, a method of transmitting interception data by a Delivery Function (DF) of a service provided in a mobile communication system is provided. The method includes the steps of: provisioning intercepted target and interception related information when a target provision request message including the intercepted target and interception related information is received from an AF; and transmitting to a Collection Function (CF) an interception-of-content message including intercepted content when an intercepted packet is received after the data session of the intercepted target is established.

According to another aspect of the present invention, a method of transmitting interception data in a DF of a service provider in a mobile communication system is provided. The method includes the steps of: transmitting a packet data intercept start message to a CF upon receiving from an AF a target provision request message including a target status which is set to active; and transmitting to the CF an interception-of-content message including an intercepted packet upon receiving the intercepted packet from the AF.

According to another aspect of the present invention, an apparatus for intercepting packet data in a mobile communication system is provided. The apparatus includes: an AF for accessing control/bearer data related to interception of an intercepted target; a CF for collecting the control/bearer data and for processing the collected control/bearer data; a DF for delivering the control/bearer data, input from the AF, to the CF; an SPADF for administrating lawful interception and for defining policy when interception-related control/bearer data is accessed and delivered to the AF and the DF; a Law Enforcement Administration Function (LEAF) for controlling electronic surveillance.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an apparatus for intercepting packet data in a mobile communication system of the present invention;

FIG. 2 illustrates a format of a Transmission Control Protocol (TCP) or User Datagram Protocol (UDP) encapsulated message in a mobile communication system according to an embodiment of the present invention;

FIG. 3 illustrates a format of a general header according to an embodiment of the present invention;

FIG. 4 is a flow diagram illustrating a method of provisioning interception related information when a data session of an intercepted target is not established in a mobile communication system according to an embodiment of the present invention;

FIG. 5 is a flow diagram illustrating a method of provisioning interception related information when a data session of an intercepted target has already been established in a mobile communication system according to an embodiment of the present invention;

FIG. 6 is a flow diagram illustrating a method which informs an intercepted target that a data session of the intercepted target is terminated when the data session is released in a mobile communication system according to an embodiment of the present invention;

FIGS. 7A and 7B are flow diagrams illustrating a method which informs an intercepted target that interception is terminated when an interception valid-time of the intercepted target is expired in a mobile communication system according to an embodiment of the present invention; and

FIG. 8 is a flow diagram illustrating a method of informing the occurrence of event when a CS rule for an IP service flow of the intercepted target is generated, modified, or deleted while intercepting communications of the intercepted target currently performing communication in a mobile communication system according to an embodiment of the present invention.

### DETAILED DESCRIPTION OF THE INVENTION

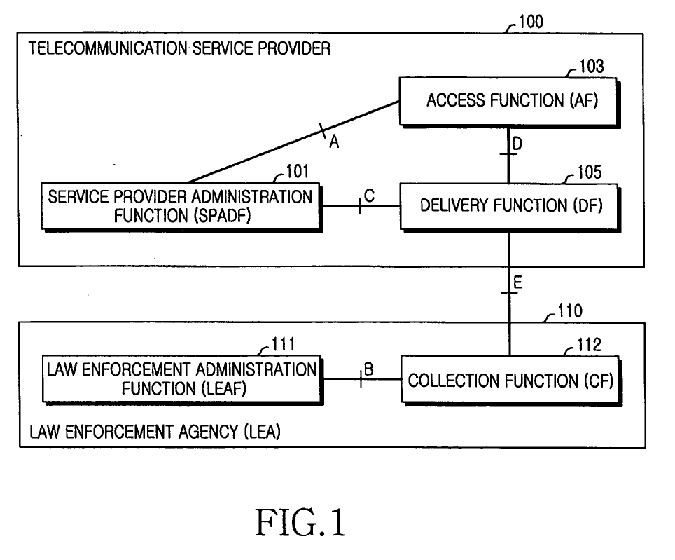

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

Hereinafter, an apparatus and method for intercepting packet data in a mobile communication system of the present invention will be described.

The mobile communication system is a mobile WiMAX system. In the following descriptions, when a parameter attribute is Mandatory (M), a parameter requests a message. When the parameter attribute is Condition (C), the parameter is required in a specific condition. When the parameter attribute is Optional (O), the parameter can be provided as an option.

FIG. 1 is a block diagram illustrating an apparatus for intercepting packet data in a mobile communication system of the present invention. The apparatus includes a telecommunication service provider 100 and a Law Enforcement Agency (LEA) 110. The telecommunication service provider 100 includes a Service Provider ADministration Function (SPADF) 101, an Access Function (AF) 103, and a Delivery Function (DF) 105. The LEA 110 includes a Law Enforcement Administration Function (LEAF) 111 and a Collection Function (CF) 112. The SPADF 101 and the AF 103 can be interconnected through an a-interface. The SPADF 101 and the DF 105 can be interconnected through a c-interface. The AF 103 and the DF 105 can be interconnected through a d-interface. The LEAF 111 and the CF 112 can be interconnected through a b-interface. The CF 112 and the DF 105 can be interconnected through an e-interface.

Referring to FIG. 1, the SPADF 101 administrates Lawful Interception (LI). The SPADF 101 delivers various pieces of interception related information (e.g., interception-related control/bearer data) to the AF 103 and the DF 105. Thus, a policy can be defined so that the interception-related control/bearer data is accessed and delivered. In this case, the interception related information is provisioned, retrieved, de-provisioned, and administrated by the AF 103 and the DF 105 according to a specific access standard or provision with respect to the SPADF 101.

In general, interception is requested by using a manual interface method and an electronic interface method. When using the manual interface method, an LI request is delivered to a service provider by document (e.g., a court-ordered letter or a fax for granting interception permission, etc.), and the service provider directly inputs intercepted target information and interception related information. When using the electronic interface method, the LI request is electrically transmitted by using a predetermined message format and a predetermined communication method. When interception is requested by using the electronic interface method, a Network Access Identifier (NAI) and a terminal Media Access Control (MAC) address may be used.

The AF 103 accesses the interception-related control/bearer data of the intercepted target. In particular, an Intercept Access Point (IAP) is used to access Content of Communication (CC) and Call-Identifying Information (CII) while avoiding interference with the intercepted target, and the accessed information is delivered to the DF 105 after being modified to a format that can be read by the DF 105. Herein, when the CC of the intercepted target is frequently accessed, system performance deteriorates since a memory has to perform a copy operation further frequently. Therefore, to prevent such system performance deterioration, the CC of the intercepted target may be accessed by using either a mirroring port or a Switching Port ANalyzer (SPAN).

The DF 105 converts the interception-related control/bearer data input from the AF 103 into an e-interface message having a predetermined format, and then delivers the message to the CF 112. A channel for control data and a channel for bearer data are located between the DF 105 and the CF 112. The channel for the control data (i.e., CII) is referred to as Call Data Channel (CDC). The channel for the bearer data (i.e., CC) is referred to as Call Content Channel (CCC). The two channels are logical channels and may use the same physical channel.

The LEAF 111 controls an electronic surveillance function. The CF 112 collects the interception-related control/bearer data of the intercepted target according to a message type defined in a standard and then processes the collected control/bearer data.

The a-interface is an access standard between the SPADF 101 and the AF 103. The c-interface is an access standard between the SPADF 101 and the DF 105. The two interfaces are provided for administration and provision of interception. The two interfaces support a Secure SHell (SSH) Command-Line Interface (CLI) in an interface communication method which reinforces security and conforms to a general provision scheme. Furthermore, the two interfaces support a Transmission Control Protocol/Internet Protocol (TCP/IP) encapsulated message or a User Datagram Protocol/Internet Protocol (UDP/IP) encapsulated message in an interface communication method in which reliable transmission is achieved by using messages. In addition, the a-interface supports an a-interface communication method that conforms to a standard defined between the SPADF 101 and the AF 103. The c-interface supports an interface communication method that conforms to a standard defined between the SPADF 101 and the DF 105.

The d-interface is an access standard between the AF 103 and the DF 105. The e-interface is an access standard between the DF 105 and the CF 112. The two interfaces are used to transmit data indicating the start and end of call and data indicating the modification of call-related information. The two interfaces support a TCP/IP encapsulated message in an interface communication method for reliable transmission and supports a UDP/IP encapsulated message in an interface communication method for fast transmission rather than reliable transmission. The d-interface supports an interface communication method that conforms to a standard defined between the AF 103 and the DF 105. The e-interface supports a File Transfer Protocol (FTP) in an interface communication method for reliable file transmission between the DF 105 and the CF 112, and supports an American Standard Code for Information Interchange (ASCII) type file transmission in an interface communication method for reliable transmission of text files.

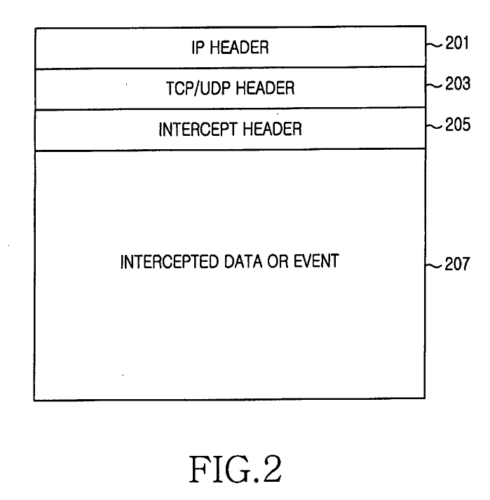

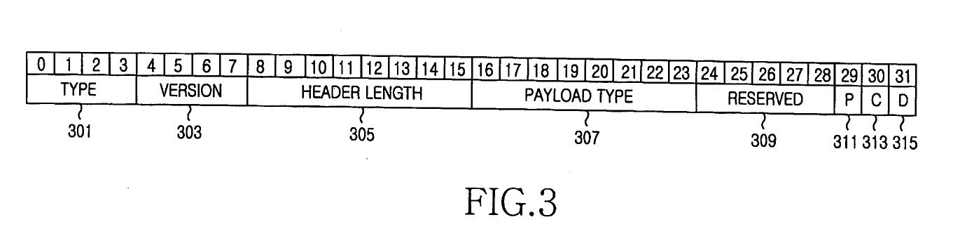

Referring to FIG. 2, a TCP/IP or UDP/IP encapsulated message includes an IP header 201, a TCP/UDP header 203, an intercept header 205, and an intercepted data or event 207. The intercept header 205 is a common header that can be commonly used to transmit the CII and the CC. Referring to FIG. 3, the common header includes a (4-bit) type field 301, a (4-bit) version field 303, an (8-bit) header length field 305, an (8-bit) payload type field 307, a (5-bit) reserved field 309, a (1-bit) P field 311, a (1-bit) C field 313, and a (1-bit) D field 315. The type field 301 represents a type of the intercept header 205. When the type of the intercept header 205 has a UDP-UnAck-format, the type is set to ‘1’. When the type of the intercept header 205 has a TCP-Ack-format, the type is set to ‘2’. The version field 303 represents a version of the intercept header 205 and is set to a default value, i.e., ‘0’. The header length field 305 represents a length (byte unit) of the intercept header 205 and is set to a default value, i.e., ‘4’. The payload type field 307 represents a type of intercepted data, and a value that is set to the payload type field 307 varies depending on a value of the P field 311. If the value of the P field 311 is ‘0’, the value of the payload type field 307 is set to ‘1’ in the case of an IPv4 packet, ‘2’ in the case of an IPv6 packet, and ‘3’ in the case of a PPP packet. If the value of the P field 311 is ‘1’, the value of the payload type field 307 is set to ‘0’ when an event is packet data session establishment, ‘1’ when the event is packet data intercept start, ‘3’ when the event is packet data serving system, and ‘4’ when the event is packet data packet filter. The P field 311 is provided to distinguish whether content inserted into a payload portion is the CII that is an event for the intercepted target or the CC that is content of communication. If the CC for the intercepted target is inserted into the payload portion, the P field 311 is set to ‘0’. If the CII for the intercepted target is inserted into the payload portion, the P field 311 is set to ‘1’. The C field 313 represents whether payload data to be intercepted and transmitted is compressed or not. If the payload data is not compressed, the C field 313 is set to ‘0’. If the payload data is compressed, the C field 313 is set to ‘1’. The D field 315 represents a transmission direction of intercepted data. If the transmission direction is directed from a terminal to a core network, the D field 315 is set to ‘0’. If the transmission direction is directed from the core network to the terminal, the D field 315 is set to ‘1’.

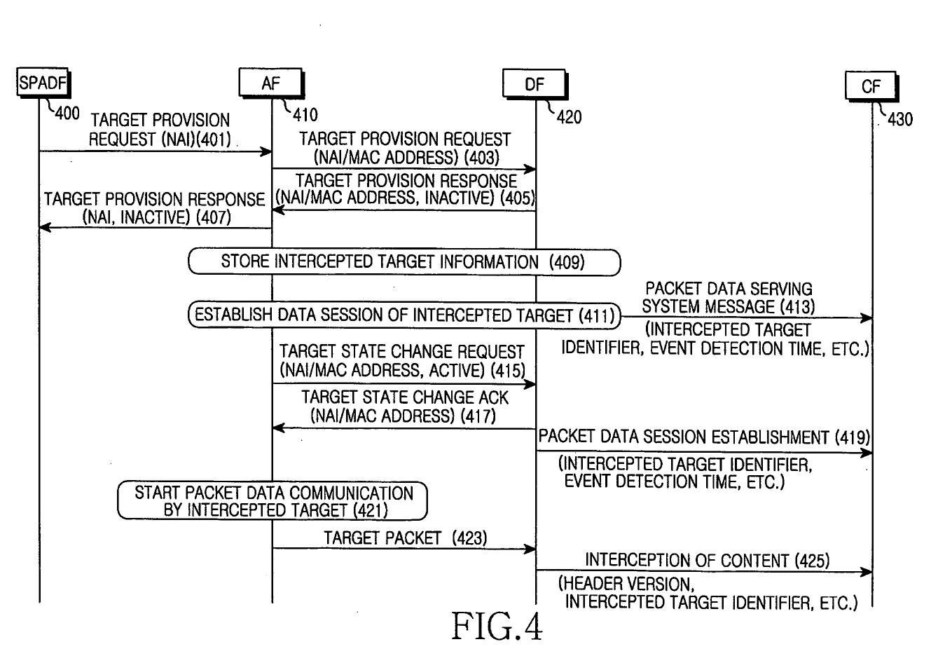

FIG. 4 is a flow diagram illustrating a method of provisioning interception related information when a data session of an intercepted target is not established in a mobile communication system according to an embodiment of the present invention. In other words, in the method, the interception related information is provisioned in a state where the data session of the intercepted target is not established, the intercepted target then starts communication, and the data session is then established to start interception.

Referring to FIG. 4, in step 401, an SPADF 400 transmits a target provision request message to an AF 410. The target provision request message is used to request the AF 410 and a DF 420 to provide interception related information of the intercepted target. The target provision request message may be transmitted between the SPADF 400 and the AF 410 (or DF 420) or between the AF 410 and the DF 420. The target provision request message includes a transaction ID (M) that is an message identifier, an NAI (M) that is a target identifier, and a target provision item (M). The target provision item (M) may include parameters described in Table 7.

In step 403, the AF 410 transmits the received target provision request message to the DF 420. Since the AF 410 can recognize a MAC address (C) of a terminal, the MAC address (C) of the terminal may be further included, as a target identifier, in a message communicated between the AF 410 and the DF 420.

Upon receiving the target provision request message, in step 405, the DF 420 transmits to the AF 410 a target provision response message in which a target status is set to inactive. The target provision response message includes a transaction ID (M), which is the same as that of the target provision request message, an NAI (M) that is a target identifier, a terminal MAC address (C), a target IP address (O), a target status [active/inactive] (M), and a reason code (C) which indicates the reason if there is a failure in provisioning.

Upon receiving the target provision response message, in step 407, the AF 410 transmits the target provision response message to the SPADF 400. In step 409, the AF 410 and the DF 420 store intercepted target information and interception related information.

When the intercepted target starts communication, in step 411, the AF 410 and the DF 420 establish a data session of the intercepted target. After establishing the data session, an access request message or an accounting request message may be received from an Authorization, Authentication and Accounting (AAA) server, or a mobile IPv4 Registration Request (RRQ) message may be received from a Home Agent (HA). In this case, in step 413, the DF 420 transmits a packet data serving system message to a CF 430. The packet data serving system message is a CII message which is used to report a system ID to the intercepted target. Further, the packet data serving system message is transmitted when a new IP is allocated by moving to an Access Service Network Gateway (ASN-GW) of a new subnet during location update or when a handover indication message is received by performing handoff between ASN-GWs. The packet data serving system message includes parameters described in Table 1 below.

TABLE 1

| | Attribute | |
|---|---|---|
| Parameter | (MOC) | Usage |
| CaseIdentity | M | identifier for identifying intercepted |
| | | target |
| IAPSystemIdentity | C | identifier for indicating system |
| | | having IAP when system storing data |
| | | located next to header is different |
| | | from system having IAP |
| TimeStamp | M | date and time for detecting event |
| SubjectIPAddess | M | IP address allocated to established |
| | | session (simple IPv4, 64-bit prefix of |
| | | simple IPv6, home IPv4 allocated by |
| | | HA). NULL value in case of failure |
| | | in session establishment. |
| SubjectIdentity | C | identifier of intercepted target that |
| | | can be easily identified by ordinary |
| | | user |
| ServingSystemIdentity | M | identifier of entity currently serving |
| | | intercepted target |
| HaIPAddress | C | IPv4 address of HA (in case of |
| | | mobile IPv4) |
| FaCoA | C | CoA allocated by FA (in case of |
| | | mobile IPv4) |

After the data session of the intercepted target is established, in step 415, the AF 410 transmits to the DF 420 a target state change request message in which a target status is set to active. The target state change request message is used when a status of the intercepted target or interception related information change and then the change is reported or requested. When the data session of the intercepted target is established or released or when target provision information (e.g., target identifier, interception valid-time, etc.) changes, the change may be reported or requested by using the target state change request message. The target state change request message includes a transaction ID (M), an NAI (M) that is a target identifier, a terminal MAC address (C), an target IP address (C), a target status [active/inactive] (C), and an interception related modification item (C).

Upon receiving the target state change request message, in step 417, the DF 420 transmits to the AF 410 a target state change response message for informing target status change, for example, when ACK is intended to be transmitted in response thereto. The target state change response message includes transaction ID (M), an NA I(M) that is a target identifier, a terminal MAC address (C), a target IP address (C), and a reason code (C) which indicates the reason if there is a failure in change.

In step 419, the DF 420 transmits a packet data session establishment message to the CF 430. The packet data session establishment message is a CII message which is used to report success or failure of packet data session establishment. Specifically, the CII message reports success or failure of: network entry for simple IPv4; network entry and registration for mobile IPv4; router advertisement including a 64-bit unique prefix allocated to the intercepted target after IP allocation for simple IPv6 is performed; and router advertisement including a 64-bit unique prefix allocated to a terminal in response to router solicitation for simple IPv6. The packet data session establishment message includes parameters described in Table 2 below.

TABLE 2

| Parameter | Attribute (MOC) | Usage |
|---|---|---|
| CaseIdentity | M | identifier for identifying intercepted target |
| IAPSystemIdentity | C | identifier for indicating system having IAP |
| | | when system storing data located next to header |
| | | is different from system having IAP |
| TimeStamp | M | date and time for detecting event |
| SubjectIPAddess | M | IP address allocated to established session |
| | | (simple IPv4, 64-bit prefix of simple IPv6, |
| | | home IPv4 allocated by HA). NULL value in case |
| | | of failure in session establishment. |
| SubjectIdentity | C | identifier of intercepted target that can be |
| | | easily identified by ordinary user |
| IPAssignment | C | indicate whether IP address is allocated |
| | | statically or dynamically |
| HaIPAddress | C | IPv4 address of HA (in case of mobile IPv4) |
| FaCoA | C | CoA allocated by FA (in case of mobile IPv4) |
| Correlation Number | C | unique number for identifying packet data |
| | | sessions respectively established for CC and |
| | | CII correlation when CC and CII are |
| | | concurrently reported |
| LocationInformation | C | location information on intercepted target |
| | | terminal (if authorized) |
| SessionEstablishement | C | failure reason information when session |
| Failure | | establishment fails for known reason. |
| CCAddress | C | IP address and port number of LEA, which is |
| | | transmitted while content of communication is |
| | | transmitted |

When the intercepted target starts packet data communication in step 421, the AF 410 intercepts a target packet. In step 423, the intercepted packet is transmitted to the DF 420. In this case, the DF 420 transmits to the CF an interception-of-content message including intercepted content of communication. The interception-of-content message is used to transmit the content of communication for the intercepted target. The interception-of-content message uses a Lawful Interception Correlation (LIC) header and includes parameters described in Table 3 below.

TABLE 3

| | Attribute | |
|---|---|---|
| Parameter | (MOC) | Usage |
| ModuleID | M | module identifier |
| LICHeaderVersion | M | version number of LIC header |
| CaseIdentity | M | identifier for identifying intercepted |
| | | target |
| Correlation Number | C | unique number for identifying packet |
| | | data sessions respectively established |
| | | for CC and CII correlation when CC |
| | | and CII are concurrently reported |
| TimeStamp | C | date and time for detecting event. |
| SequenceNumber | C | value which is incremented by one |
| | | when transmitted by intercepting an IP |
| | | packet for packet data session and thus |
| | | determines a transmission sequence in |
| | | one packet data session (not required |
| | | when using sequence providing |
| | | transport protocol, e.g., Stream Control |
| | | Transmission Protocol (SCTP), TCP, |
| | | etc.) |
| IPPacketDirection | C | transmission direction of intercepted |
| | | target content of communication (IP |
| | | packet) |

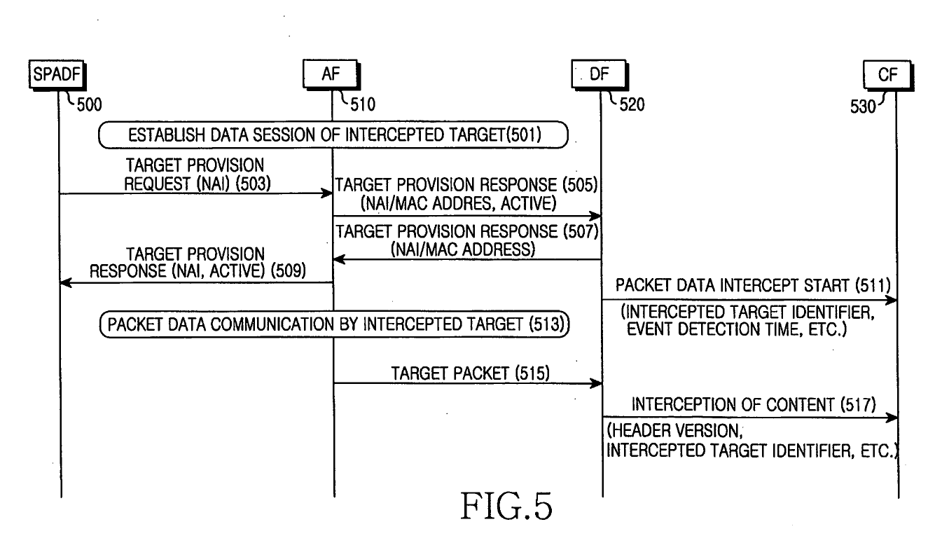

FIG. 5 is a flow diagram illustrating a method of provisioning interception related information when a data session of an intercepted target has already been established in a mobile communication system according to an embodiment of the present invention. In other words, in the method, regarding communication of an intercepted target currently performing communication, the start of interception for the intercepted target is informed, and interception starts immediately thereafter so as to transmit intercepted content.

Referring to FIG. 5, the data session of the intercepted target is established to an AF 510 in step 501. In this state, in step 503, an SPADF 500 transmits to the AF 510 a target provision request message that requests provisioning of interception related information of the intercepted target. The target provision request message includes a transaction ID (M) that is a message identifier, an NAI (M) that is a target identifier, and an interception related provision item (M).

Upon receiving the target provision request message, in step 505, the AF 510 transmits to a DF 520 the target provision request message by appending a target status (M), which is set to active, and a terminal MAC address (C) as a terminal identifier. In this case, the DF 520 transmits a target provision response message to the AF 510 in step 507. Upon receiving the target provision request message, in step 509, the AF 510 appends a target status (M), which is set to active, to the received target provision request message, and then transmits the resultant message to the SPADF 500. The target provision response message transmitted in step 507 includes a transaction ID (M), an NAI (M) that is a target identifier, a terminal MAC address (C), a target IP address (O), and a reason code (C) which indicates the reason if there is a failure in provisioning. The target provision response message transmitted in step 509 further includes a target status (M) in addition to the parameters of the target provision response message transmitted in step 507. In step 511, the DF 520 transmits a packet data intercept start message to a CF 530. The packet data intercept start message is a CII message which is used to start interception when an interception request is received in a state that session is established after the intercepted target has already been successfully established to a network entry. The packet data intercept start message includes parameters described in Table 4 below.

TABLE 4

| Parameter | Attribute (MOC) | Usage |
|---|---|---|
| CaseIdentity | M | identifier for identifying intercepted target |
| IAPSystemIdentity | C | identifier for indicating system having IAP |
| | | when system storing data located next to header |
| | | is different from system having IAP |
| TimeStamp | M | date and time for detecting event |
| SubjectIPAddess | M | IP address allocated to established session |
| | | (simple IPv4, 64-bit prefix of simple IPv6, |
| | | home IPv4 allocated by HA). NULL value in case |
| | | of failure in session establishment. |
| SubjectIdentity | C | identifier of intercepted target that can be |
| | | easily identified by ordinary user |
| IPAssignment | C | indicate whether IP address is allocated |
| | | statically or dynamically |
| HaIPAddress | C | IPv4 address of HA (in case of mobile IPv4) |
| FaCoA | C | CoA allocated by FA (in case of mobile IPv4) |
| Correlation Number | C | unique number for identifying packet data |
| | | sessions respectively established for CC and |
| | | CII correlation when CC and CII are |
| | | concurrently reported |
| LocationInformation | C | location information on intercepted target terminal |
| CCAddress | c | IP address and port number of LEA, which is |
| | | transmitted while content of communication is |
| | | transmitted |

When the intercepted target starts packet data communication in step 513, the AF 510 AF 510 intercepts a packet of the intercepted target. The AF 510 transmits the intercepted packet to the DF 520 in step 515. In step 517, the DF 520 transmits to the CF 530 an interception-of-content message including the intercepted Content of Communication. The interception of content message includes parameters described in Table 3 above.

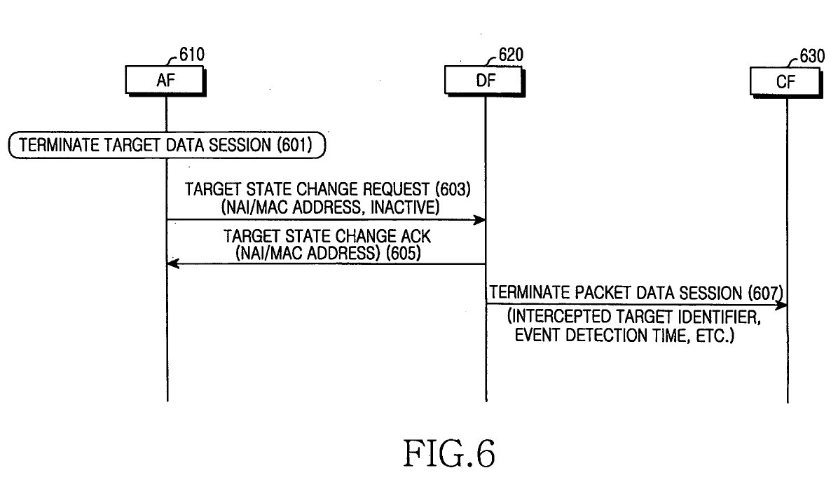

FIG. 6 is a flow diagram illustrating a method which informs an intercepted target that a data session of the intercepted target is terminated when the data session is released in a mobile communication system according to an embodiment of the present invention.

Referring to FIG. 6, when the intercepted target releases the data session or disconnects communication in step 601, the data session of the intercepted target is terminated. In this case, in step 603, an AF 610 transmits to a DF 620 a target state change request message in which a target status is set to inactive. The target state change request message includes a transaction ID (M), an NAI (M) that is a target identifier, a terminal MAC address (C), a target IP address (C), a target status [active/inactive] (C), and an interception related modification item (C). In step 605, the DF 620 transmits to the AF 610 a target state change request message (e.g., a target state change ACK message when ACK is intended to be transmitted in response). In step 607, the DF 620 transmits to a CF 630 a packet data session termination message for reporting the termination of the packet data session. The packet data session termination message is a CII message that reports the termination of the packet data session. The Cll message is transmitted in the following cases: when a power-down operation is performed due to deregistration; when a power-down location update operation is performed; when a prefix validity time is over with respect to simple IPv6; or when a deregistration operation is performed with respect to mobile IPv4. The CII message includes parameters described in Table 5 below.

TABLE 5

| | Attribute | |
|---|---|---|
| Parameter | (MOC) | Usage |
| CaseIdentity | M | identifier for identifying intercepted target |
| IAPSystemIdentity | C | identifier for indicating system |
| | | having IAP when system storing data |
| | | located next to header is different |
| | | from system having IAP |
| TimeStamp | M | date and time for detecting event |
| SubjectIPAddess | M | IP address allocated to established |
| | | session (simple IPv4, 64-bit prefix |
| | | of simple IPv6, home IPv4 allocated |
| | | by HA). NULL value in case of failure |
| | | in session establishment. |
| HaIPAddress | C | IPv4 address of HA (in case of mobile IPv4) |
| FaCoA | C | CoA allocated by FA (in case of mobile IPv4) |
| Correlation Number | C | unique number for identifying packet |
| | | data sessions respectively |
| | | established for CC and CII |
| | | correlation when CC and CII are |
| | | concurrently reported |
| LocationInformation | C | location information on intercepted |
| | | target terminal |
| SessionTerminationReason | C | record failure reason when session |
| | | is released |

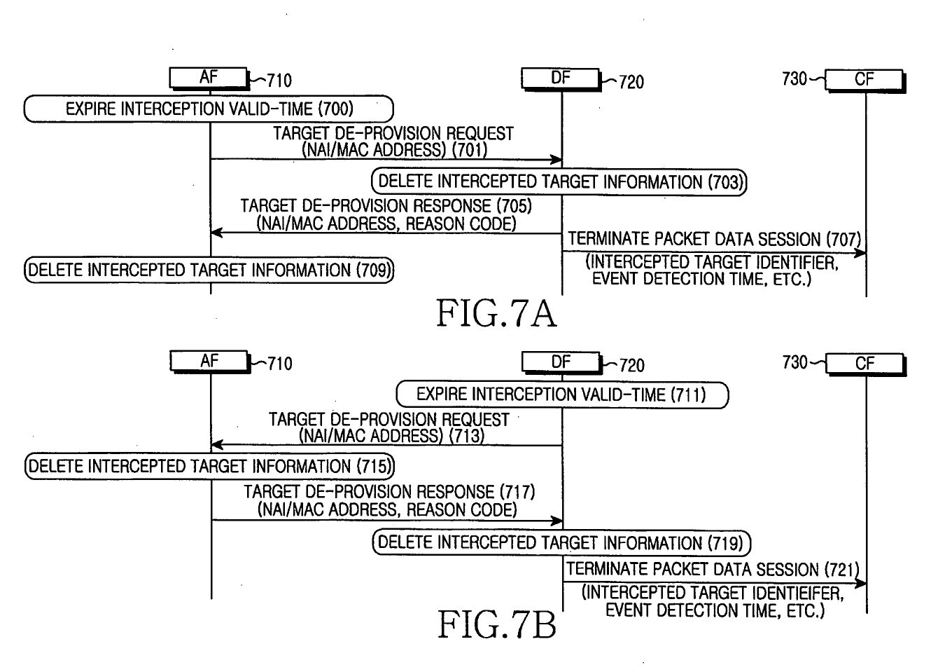

FIGS. 7A and 7B are flow diagrams illustrating a method which informs an intercepted target that interception is terminated when an interception valid-time of the intercepted target is expired in a mobile communication system according to an embodiment of the present invention.

Referring to FIGS. 7A and 7B, in step 700, an interception valid-time is expired in an AF 710. In this case, in step 701, the AF 710 transmits a target de-provision request message to a DF 720. The target de-provision request message is used to request the AF 710 and the DF 720 to delete intercepted target and interception related information. The target de-provision request message may be transmitted between an SPADF and the AF 710 or between the AF 710 and the DF 720. The target de-provision request message includes a transaction ID (M) that is a message identifier, an NAI (M) that is a target identifier, a terminal MAC address (C), and an interception related provision item (C).

Upon receiving the target de-provision request message, in step 703, the DF 720 deletes intercepted target information (.i.e., intercepted target and interception related information). In step 705, the DF 720 transmits a target de-provision response message to the AF 710. In step 707, the DF 720 transmits a packet data session termination message to an CF 730. The target de-provision response message includes a transaction ID (M) that is a message identifier, an NAI (M) that is a target identifier, a terminal MAC address (C), and a reason code (C) which indicates the reason if there is a failure in termination. The packet data session termination message includes parameters described in Table 5 above. When received, the AF 710 deletes the intercepted target information in step 709.

Alternatively, when the interception valid-time is expired in the DF 720 in step 711, the DF 720 transmits the target de-provision request message to the AF 710 in step 713. When received, the AF 710 deletes the intercepted target information in step 715. Then, the AF 710 transmits the target de-provision response message to the DF 720 in step 717. In this case, the DF 720 deletes the intercepted target information in step 719, and transmits the packet data session termination message to the CF 730 in step 721.

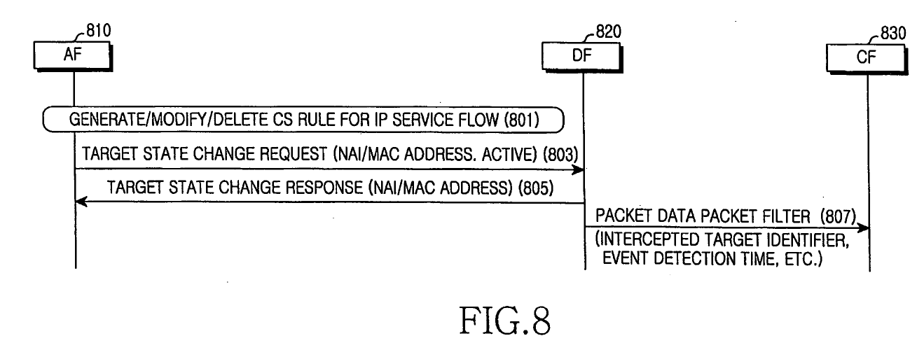

FIG. 8 is a flow diagram illustrating a method of informing the occurrence of event when a CS rule for an IP service flow of the intercepted target is generated, modified, or deleted while intercepting communications of the intercepted target currently performing communication in a mobile communication system according to an embodiment of the present invention.

Referring to FIG. 8, in step 801, a CS rule for an IP service flow of the intercepted target is generated/modified/deleted by an AF 810 while communications of the intercepted target is being intercepted as shown in FIG. 4. In this case, in step 803, the AF 810 transmits to a DF 820 a target state change request in which a target statue is set to active. In step 805, the DF 820 transmits a target state change response message to the AF 810. In step 807, the DF 820 transmits a packet data packet filter message to a DF 830. The packet data packet filter message is transmitted when a new CS rule for an interception terminal is generated/modified/deleted. The packet data packet filter message includes parameters described in Table 6 below.

TABLE 6

| | Attribute | |
|---|---|---|
| Parameter | (MOC) | Usage |
| CaseIdentity | M | identifier for identifying |
| | | intercepted target |
| IAPSystemIdentity | C | identifier for indicating system |
| | | having IAP when system storing |
| | | data located next to header is |
| | | different from system having IAP |
| TimeStamp | M | date and time for detecting event |
| SubjectIPAddess | M | IP address allocated to established |
| | | session (simple IPv4, 64-bit prefix |
| | | of simple IPv6, home IPv4 |
| | | allocated by HA). NULL value in |
| | | case of failure in session |
| | | establishment. |
| SubjectIdentity | C | identifier of intercepted target that |
| | | can be easily identified by ordinary |
| | | user |
| HaIPAddress | C | IPv4 address of HA (in case of |
| | | mobile IPv4) |
| FaCoA | C | CoA allocated by FA (in case of |
| | | mobile IPv4) |
| PacketFilterInformation | M | packet filter information |
| Correlation Number | C | unique number for identifying |
| | | packet data sessions respectively |
| | | established for CC and CII |
| | | correlation when CC and CII are |
| | | concurrently reported |

The aforementioned interception related provision item may include parameters described in Table 7 below. Of course, some of the parameters may be modified or added at the request of a service provider.

TABLE 7

| Item | AF | DF |
|---|---|---|
| intercepted target | terminal NAI | terminal NAI |
| identifier | tetrminal MAC address | terminal MAC address |
| | terminal IP address | terminal IP address |
| target identifier | DF IP address, | CF IP address, port |
| (when using TCP or | port number (TCP/UDP) | number (TCP/UDP) |
| UDP) | | |
| target identifier | not required | CF IP address, FTP, |
| (when using FTP) | | port number, user ID, |
| | | password |
| transmission between | TCP, UDP, proprietary | TCP, UDP, proprietary |
| AF and DF | | |
| transmission between | not required | TCP, UDP, FTP |
| DF and CF | | |
| intercepted target | required | required |
| interception | | |
| valid-time | | |

Although not mentioned in exemplary embodiments of the present invention, other messages may be required for system operation. Examples of such messages include a message that retrieves intercepted target and interception related information provided between the SPADF and the AF or between the AF and the DF, a message that requests synchronization for the intercepted target and interception related information provided between the AF and the DF, a message that retrieves a state of the intercepted target and interception related information between the AF and the DF, and a message that checks for a connection state between the AF and the DF.

In order to retrieve the provided intercepted target and interception related information, a retrieve-target-info-request message is sent to the AF and the DF and includes a transaction ID (M), a target identifier NAI (M), and a terminal MAC address (C). A retrieve-target-info-response message is sent in response to the retrieve-target-info-request message and includes a transaction ID (M), which is the same as that of the retrieve-target-info-request message, an NAI (M) that is a target identifier, a terminal MAC address (C), an interceptor IP address (C), a target status [active/inactive](C), and an interception related provision item (M).

An intercept-sync-request message is used to request synchronization for the intercepted target and interception related information. The intercept-sync-request message includes a transaction ID (M), an NAI (M) that is a target identifier, a terminal MAC address (C), an interceptor IP address (C), and an interception related provision item (M). An intercept-sync-response message is sent in response to the intercept-sync-request message. The intercept-sync-response message includes a transaction ID (M) that is the same as that of the intercept synch request message, an NAI (M) that is a target identifier, a terminal MAC address (C), an interceptor IP address (C), and a reason code (C) which indicates the reason if there is a failure in synchronization.

A retrieve-target-status-request message is transmitted between an AF and a DF so as to retrieve a state of the intercepted target or interception related information. The retrieve-target-status-request message includes a transaction ID (M), an NAI (M) that is a target identifier, a terminal MAC address (C), and an interceptor IP address (C). A retrieve-target-status-response message is sent in response to the retrieve-target-status-request message, and includes a transaction ID (M) that is the same as that of the retrieve-target-status-request message, an NAI (M) that is a target identifier, a terminal MAC address (C), an interception IP address (C), a target status [active/inactive] (C), and a reason code (C) which indicates the reason if there is a failure in retrieval.

As a message for checking a connection state between the AF and the DF, a keep-alive-request message is a query message for inquiring whether connection between the AF and the DF is accurately made. The message includes a transaction ID (M). A keep-alive-response message is sent in response to the keep-alive-request message and includes a transaction ID (M), which is the same as that of the keep-alive-request message, and a failure reason code (C) that indicates the reason if there is a failure in checking the connection state.

According to the present invention, function blocks having an LI architecture and interfaces between the function blocks are concretely defined in a mobile communication system. Therefore, solutions capable of properly performing LI can be provided. In addition, the present invention is compliant with existing LI on packet data.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of intercepting packet data by an Access Function (AF) of a service provider in a mobile communication system, the method comprising:
storing intercepted target and interception related information when a target provision request message including the intercepted target and interception related information is received from a Service Provider ADministration Function (SPADF);
establishing a data session of the intercepted target according to whether the data session of the intercepted target is established; and
intercepting a packet of the intercepted target when the intercepted target starts packet data communication.

2. The method of claim 1, further comprising:
if the data session of the intercepted target is not established: transmitting the target provision request message to a Delivery Function (DF) when received; and transmitting a target provision response message, in which a target status is set to inactive, to the SPADF when the message is received from the DF.

3. The method of claim 2, further comprising;
after establishing the data session of the intercepted target, transmitting a target state change request message, in which a target status is set to active, to the DF and receiving a target state change response message from the DF.

4. The method of claim 1, further comprising:
if the data session of the intercepted target is established:
transmitting to the DF the target provision request message by allowing a target status of the message to be set to active upon receiving the message; and
transmitting to the SPADF the target provision response message by allowing a target status of the message to be set to active upon receiving the message from the DF.

5. The method of claim 1, further comprising transmitting the intercepted packet to the DF.

6. The method of claim 1, further comprising:
upon completing the data session of the intercepted target, transmitting to the DF a target state change request message in which a target status is set to inactive and receiving from the DF a target state change response message.

7. The method of claim 1, further comprising:
upon completing an interception valid-time of the intercepted target, transmitting a target de-provision request message to the DF; and
upon receiving the target de-provision response message from the DF, deleting the intercepted target and interception related information stored.

8. The method of claim 1, further comprising:
upon receiving a target de-provision request message from the DF, deleting the intercepted target and interception related information stored and transmitting a target de-provision response message to the DF.

9. The method of claim 1, further comprising:
when a CS regulation of an IP service flow for the intercepted target is created, modified, or deleted, transmitting to the DF a target state change request message in which a target status is set and receiving a target state change response message from the DF.

10. A method of transmitting interception data by a Delivery Function (DF) of a service provided in a mobile communication system, the method comprising:
provisioning intercepted target and interception related information when a target provision request message including the intercepted target and interception related information is received from an Access Function (AF); and
transmitting to a Collection Function (CF) an interception-of-content message including intercepted content when an intercepted packet is received after the data session of the intercepted target is established.

11. The method of claim 10, further comprising:
upon receiving the target provision request message, transmitting to the AF a target provision response message in which a target status is set to inactive.

12. The method of claim 11, further comprising:
after the data session of the intercepted target is established, upon receiving from the AF a target state change request message in which a target status is set to active, transmitting to the CF a packet data session establishment message for reporting whether the data session is successfully established.

13. The method of claim 10, further comprising;
after the data session of the intercepted target is established, upon generation of a specific event, transmitting to the CF a packet data serving system message for reporting an Identifier (ID) of a system for the intercepted target.

14. The method of claim 13, wherein the specific event occurs in a case selected from a group consisting of:
when an access request message or an accounting request message is received from an Authorization, Authentication, and Accounting (AAA) server;
when a mobile IPv4 Registration Request (RRQ) message is received from a Home Agent (HA);
when a new Internet Protocol (IP) is allocated by moving to a new subnet Access Service Network Gateway (ASN-GW) during location update; and
when a handover indication message is received by performing handoff between ASN-GWS.

15. The method of claim 10, further comprising transmitting a packet data packet filter message for reporting the target status to the CF when a target state change request message, in which the target status is set when a CS rule for an IP service flow is generated/modified/deleted, is received from the AF.

16. The method of claim 10, further comprising transmitting a packet data session termination message to the CF when a target state change request message, in which a target status is set to inactive, is received from the AF.

17. The method of claim 10, further comprising deleting the intercepted target and interception related information stored and transmitting the packet data session termination message to the CF when an interception valid-time of the intercepted target is expired or when a target de-provision request message is received from the AF.

18. A method of transmitting interception data in a Delivery Function (DF) of a service provider in a mobile communication system, the method comprising:
transmitting a packet data intercept start message to a Collection Function (CF) upon receiving from an Access Function (AF) a target provision request message including a target status which is set to active; and
transmitting to the CF an interception-of-content message including an intercepted packet upon receiving the intercepted packet from the AF.

19. An apparatus for intercepting packet data in a mobile communication system, the apparatus comprising:
an Access Function (AF) for accessing control/bearer data related to interception of an intercepted target;
a Collection Function (CF) for collecting the control/bearer data and for processing the collected control/bearer data;
a Delivery Function (DF) for delivering the control/bearer data, input from the AF, to the CF;
a Service Provider ADministration Function (SPADF) for administrating lawful interception and for defining policy when interception-related control/bearer data is accessed and delivered to the AF and the DF;
a Law Enforcement Administration Function (LEAF) for controlling electronic surveillance.

20. The apparatus of claim 19, wherein the SPADF and the DF is interconnected through a c-interface, the AF and the DF is interconnected through a d-interface, the LEAF and the CF is interconnected through a b-interface, and the CF and the DF is interconnected through an e-interface.

21. The apparatus of claim 20, wherein the a-interface or c-interface communicates by using at least one selected from a group consisting of a Secure SHell (SSH) Command-Line Interface (CLI), a TCP/IP encapsulated message, and a UDP/IP encapsulated message.

22. The apparatus of claim 20, wherein the d-interface communicates by using at least one selected from a group consisting of a TCP/IP encapsulated message and a UDP/IP encapsulated message.

23. The apparatus of claim 20, wherein the e-interface communicates by using at least one selected from a group consisting of a TCP/IP encapsulated message, a UDP/IP encapsulated message, a File Transfer Protocol (FTP), and an American Standard Code for Information Interchange (ASCII) text.

24. The apparatus of claim 21, wherein the encapsulated message comprises at least one header selected from a group consisting of an Internet Protocol (IP) header, a TCP/UDP header, an intercept header, and an intercepted data or event header.

25. The apparatus of claim 24, wherein the intercept header comprises at least one field selected from a group consisting of a type field, a version field, a header length field, a payload type field, a field indicating whether payload data is control data or bearer data, a field indicating whether payload data is compressed, and a field indicating a transmission direction of intercepted data.
